(19) United States
(12) Patent Application Publication
(10) Pub. No.: US 2026/0160995 A1
(43) Pub. Date: Jun. 11, 2026

(54) SURFACE RELIEF GRATING WITH METAL INSERT

(71) Applicant: TOKYO ELECTRON LIMITED, Tokyo (JP)

(72) Inventors: Ryan BURNS, Austin, TX (US); Takuya HIGUCHI, Tokyo (JP); Michael CARCASI, Austin, TX (US); Sean BERGLUND, Austin, TX (US); Ankur AGARWAL, Austin, TX (US)

(73) Assignee: TOKYO ELECTRON LIMITED, Tokyo (JP)

(21) Appl. No.: 18/971,108

(22) Filed: Dec. 6, 2024

(51) Int. Cl. G02B 27/01

(52) U.S. Cl. CPC G02B 27/0101

(57) ABSTRACT

An optical apparatus includes a waveguide structure, a grating pattern positioned on a surface of the waveguide structure and including a plurality of protrusion structures, and a respective insert structure positioned in each of the protrusion structures and on the surface of the waveguide structure, which results in a plurality of insert structures. The protrusion structures have a higher refractive index (RI) than the waveguide structure. The insert structures are reflective to an incident light beam. The protrusion structures and the insert structures are configured to redirect the incident light beam into the waveguide structure.

### FIELD OF THE INVENTION

This disclosure relates generally to optical apparatuses and methods of microfabrication and more specifically to waveguides and methods of waveguide fabrication.

### BACKGROUND

A waveguide is a physical structure that guides electromagnetic waves, such as microwaves, radio waves, and/or light waves, from one point to another. For instance, a waveguide can guide waves by restricting the transmission of energy to one direction or confining electromagnetic waves within a tube where they reflect off the walls and travel from one end to the other. Waveguides are used in many applications including optical fibers, radar technology, microwave engineering, etc.

### SUMMARY

The present disclosure relates to an optical apparatus and a method of forming the same.

According to a first aspect of the disclosure, an optical apparatus is provided. The optical apparatus includes a waveguide structure, a grating pattern positioned on a surface of the waveguide structure and including a plurality of protrusion structures, and a respective insert structure positioned in each of the protrusion structures and on the surface of the waveguide structure, which results in a plurality of insert structures. The protrusion structures have a higher refractive index (RI) than the waveguide structure. The insert structures are reflective to an incident light beam. The protrusion structures and the insert structures are configured to redirect the incident light beam into the waveguide structure.

In some embodiments, the surface of the waveguide structure is in direct contact with the insert structures.

In some embodiments, the surface of the waveguide structure is in direct contact with the protrusion structures.

In some embodiments, the insert structures each are offset from a center of a respective protrusion structure.

In some embodiments, the insert structures each has a respective first side surface covered by a respective protrusion structure and a respective second side surface covered by the respective protrusion structure or exposed.

In some embodiments, the protrusion structures have a rectangular, staircase or triangular shape in a cross-sectional view.

In some embodiments, the insert structures have a reflection factor of the incident light beam of 50% to 100%.

In some embodiments, the protrusion structures have a first RI of 2.0 to 2.6, and the waveguide structure has a second RI of 1.7 to 2.3.

In some embodiments, the insert structures include a metal material.

In some embodiments, the waveguide structure is transparent and includes a treated glass, and the insert structures include Al or Cu.

In some embodiments, the waveguide structure includes an incoupling region, a waveguide region and an outcoupling region. The waveguide structure, the protrusion structures and the insert structures form a waveguide combiner.

In some embodiments, the protrusion structures and the insert structures are positioned in the incoupling region.

In some embodiments, the optical apparatus further includes a light source configured to provide the incident light beam.

According to a second aspect of the disclosure, a method of manufacturing an optical apparatus is provided. The method includes forming a patterned layer on a surface of a waveguide structure. The patterned layer includes a first material and a plurality of insert structures positioned in the first material. The first material includes an overburden portion that covers the insert structures and bottom portions positioned between the insert structures. The method also includes etching the patterned layer to form a grating pattern that includes a plurality of protrusion structures. Each insert structure is positioned in a respective protrusion structure. The waveguide structure generally has a lower refractive index (RI) than the protrusion structures. The insert structures include a second material that is reflective to an incident light beam. The protrusion structures and the insert structures are configured to redirect the incident light beam into the waveguide structure. The surface of the waveguide structure is in direct contact with the insert structures.

In some embodiments, the protrusion structures each have a rectangular shape in a cross-sectional view. The protrusion structures can be etched so that the protrusion structures have a staircase shape in the cross-sectional view.

In some embodiments, the protrusion structures each have a rectangular shape in a cross-sectional view. The protrusion structures are etched at an angle so that the protrusion structures have a triangular shape in the cross-sectional view.

In some embodiments, a film of the first material is formed on the waveguide structure. The film of the first material is etched to form the bottom portions. The insert structures are formed between the bottom portions. The overburden portion is formed over the insert structures and the bottom portions.

In some embodiments, a film of the second material is formed on the waveguide structure. The film of the second material is etched to form the insert structures. The first material is deposited to form the bottom portions and the overburden portion.

In some embodiments, a patterned photoresist is formed on the waveguide structure. The second material is deposited into openings of the patterned photoresist to form the insert structures. The patterned photoresist is removed. The first material is deposited to form the bottom portions and the overburden portion.

In some embodiments, depositing the second material includes forming a self-assembled layer in the openings of the patterned photoresist and depositing the second material selectively on the self-assembled layer.

Note that this summary section does not specify every embodiment and/or incrementally novel aspect of the present disclosure or claimed invention. Instead, this summary only provides a preliminary discussion of different embodiments and corresponding points of novelty. For additional details and/or possible perspectives of the invention and embodiments, the reader is directed to the Detailed Description section and corresponding figures of the present disclosure as further discussed below.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be increased or reduced for clarity of discussion.

FIG. 1 shows a schematic of an optical apparatus in accordance with some embodiments of the present disclosure.

FIG. 2A shows a vertical cross-sectional view of an optical apparatus in accordance with one embodiment of the present disclosure.

FIG. 2A′ shows a top-down view along the line cut AA′ in FIG. 2A in accordance with one embodiment of the present disclosure.

FIG. 2B shows a vertical cross-sectional view of an optical apparatus in accordance with another embodiment of the present disclosure.

FIG. 2C shows a vertical cross-sectional view of an optical apparatus in accordance with yet another embodiment of the present disclosure.

FIG. 2D shows a vertical cross-sectional view of an optical apparatus in accordance with yet another embodiment of the present disclosure.

FIG. 2E shows a perspective view of an optical apparatus in accordance with yet another embodiment of the present disclosure.

FIG. 3A shows a vertical cross-sectional view of an optical apparatus in accordance with some embodiments of the present disclosure.

FIG. 3B shows a vertical cross-sectional view of an electrical field of an optical apparatus in accordance with some embodiments of the present disclosure.

FIG. 3C shows efficiency data of an optical apparatus in accordance with some embodiments of the present disclosure.

FIG. 4A shows a vertical cross-sectional view of an optical apparatus in accordance with some embodiments of the present disclosure.

FIG. 4B shows a vertical cross-sectional view of an electrical field of an optical apparatus in accordance with some embodiments of the present disclosure.

FIG. 4C shows efficiency data of an optical apparatus in accordance with some embodiments of the present disclosure.

FIG. 5 shows a flow chart of a process for manufacturing an optical apparatus, in accordance with some embodiments of the present disclosure.

FIGS. 6A, 6B, 6C, 6D, 6E, 6F, 6G and 6H show vertical cross-sectional views of an optical apparatus at various intermediate steps of manufacturing, in accordance with some embodiments of the present disclosure.

FIGS. 7A, 7B, 7C and 7D show vertical cross-sectional views of an optical apparatus at various intermediate steps of manufacturing, in accordance with some embodiments of the present disclosure.

FIGS. 8A, 8B, 8C, 8D and 8E show vertical cross-sectional views of an optical apparatus at various intermediate steps of manufacturing, in accordance with some embodiments of the present disclosure.

FIGS. 9A, 9B, 9C, 9D and 9E show vertical cross-sectional views of an optical apparatus at various intermediate steps of manufacturing, in accordance with some embodiments of the present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed. Further, spatially relative terms, such as “top,” “bottom,” “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

The order of discussion of the different steps as described herein has been presented for clarity's sake. In general, these steps can be performed in any suitable order. Additionally, although each of the different features, techniques, configurations, etc. herein may be discussed in different places of this disclosure, it is intended that each of the concepts can be executed independently of each other or in combination with each other. Accordingly, the present invention can be embodied and viewed in many different ways.

In the drawings, like reference numerals designate identical or corresponding parts throughout the several views. Additionally, as used herein, the words “a”, “an” and the like generally carry a meaning of “one or more”, unless stated otherwise.

Furthermore, the terms, “approximately”, “approximate”, “about” and similar terms generally refer to ranges that include the identified value within a margin of 20%, 10%, or preferably 5%, and any values therebetween.

A numerical range represented by “to” or “from . . . to . . . ” includes numerical values at both ends, unless specified otherwise.

Augmented reality (AR) enables an experience in which a user can see through a display lens to view the surrounding environment as well as see images of virtual objects that are generated for display and appear as part of the environment. Accordingly, AR can include any type of input, such as audio and haptic inputs, virtual images, graphics, and videos, which augments or enhances the environment experienced by the user.

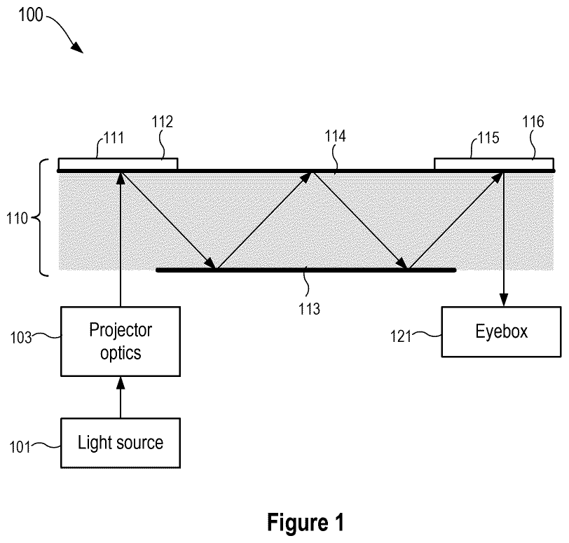

FIG. 1 shows a schematic of an optical apparatus, also referred to as an augmented reality (AR) system 100, in accordance with some embodiments of the present disclosure. As illustrated, the AR system 100 includes a light source 101 (also referred to as a display source) that is configured to provide an incident light beam represented by an arrow. The light source 101 can include microdisplays such as light-emitting diodes, organic light-emitting diodes, liquid crystal displays, a digital micromirror device, a laser beam scanning device and/or the like. The incident light beam may combine light from the microdisplays and light from a real world e.g. a surrounding environment. The AR system 100 also includes optics that direct the incident light beam to a receiver, or rather, eyes of a wearer of the AR system 100 as represented by an eyebox 121. The optics can project augmented information from the microdisplays on the real world by creating virtual images overlaid onto the surrounding environment.

For instance, the optics may include projector optics 103 and a waveguide combiner 110 having an incoupling region 112, a waveguide region 114 and an outcoupling region 116. The waveguide combiner 110 can include an incoupler 111 in the incoupling region 112, a waveguide structure 113 in the waveguide region 114 and an outcoupler 115 in the outcoupling region 116. As shown, the projector optics 103 can project or direct the incident light beam from the light source to the incoupler 111 of the waveguide combiner 110. Subsequently, at least part of the incident light beam can be coupled into the waveguide combiner 110 by the incoupler 111 and then reflected through and across the waveguide region 114, for example by total internal reflection by the waveguide structure 113, into the outcoupling region 116, before being coupled out of the waveguide combiner 110 by the outcoupler 115 and directed to the eyebox 121.

In a non-limiting example, the basic structure of a waveguide-based AR display system (e.g. 100) may include a display source (e.g. 101), projector optics (e.g. 103), an incoupling waveguide (e.g. 111), an expansion/fold grating (e.g. 113) and an output grating (e.g. 115). In some examples, the expansion grating can also function as the outcoupler grating, in which case a separate output grating may not be needed.

According to aspects of the present disclosure, techniques herein can employ a flat, transparent glass component (e.g. 113) that possesses an index of refraction allowing for total internal reflection of light as the light travels through a waveguide (e.g. 110). The light is usually introduced into the waveguide (e.g. 110) from a display (e.g. 101), expanded inside the waveguide (e.g. 110), and then emitted to an eyebox (e.g. 121). The process of incoupling and/or outcoupling the light can be accomplished through periodic gratings (e.g. 111 and 115) that are approximately the same size as the wavelength of light. These periodic gratings (e.g. 111 and 115) can include surface relief gratings and/or volume holographic gratings, depending on the specific design requirements. Alternatively or additionally, incoupling and/or outcoupling the light can be accomplished by a transflective mirror array (e.g. 111 and 115).

A surface relief grating can be created from slanted relief structures and have any shape suitable for light reflection. In conventional technologies, slanted surface relief gratings are often created using nano-imprint lithography in a fairly complex process. The industry needs innovation around scalable, less expensive processes that would still yield the same or improved performance. Techniques herein provide a method of forming surface relief gratings by film deposition, etching and photolithography, which is a more facile, scalable and economical compared to other existing alternatives.

Expansion gratings (e.g. 113) within a waveguide (e.g. 110) often have a different purpose compared to incoupling or outcoupling gratings (e.g. 111 or 115). For example, the purpose of an expansion grating (e.g. 113) can be to expand the field of view of the input display light (e.g. 101), and to modulate the output light in such a way as to keep the uniformity constant across the eyebox (e.g. 121). Expansion gratings (e.g. 113) may optionally have variable height, duty cycle (e.g. critical dimension) or both as light travels down the waveguide (e.g. 110). Innovating around lower-cost methods to create such gratings is important.

The incident light beam may include at least one wavelength of visible light without particular limitations. The incident light can include a single wavelength, a plurality of discrete wavelengths and/or a continuous band of wavelengths. For instance, the incident light beam may include red light, green light and/or blue light. In a non-limiting example, the incident light beam includes light of 660 nm, 532 nm and/or 473 nm.

Techniques herein provide methodologies for enhancing the effectiveness of an incoupler grating while keeping the manufacturing costs at a reasonable level. By strategically placing metal deposition between a waveguide material and the binary or staircase grating, it is possible to enhance the diffraction efficiency. Techniques herein utilize incoupler surface relief gratings to enhance the efficiency of incoupler gratings while maintaining reasonable manufacturing costs. This approach involves depositing a thin reflective layer within the binary surface relief grating to improve the diffraction efficiency of the incoupler.

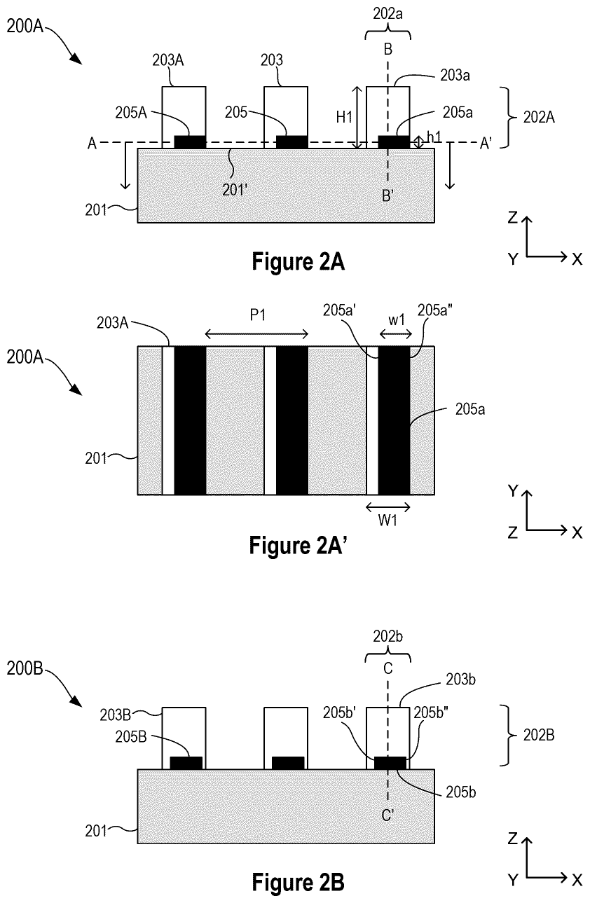

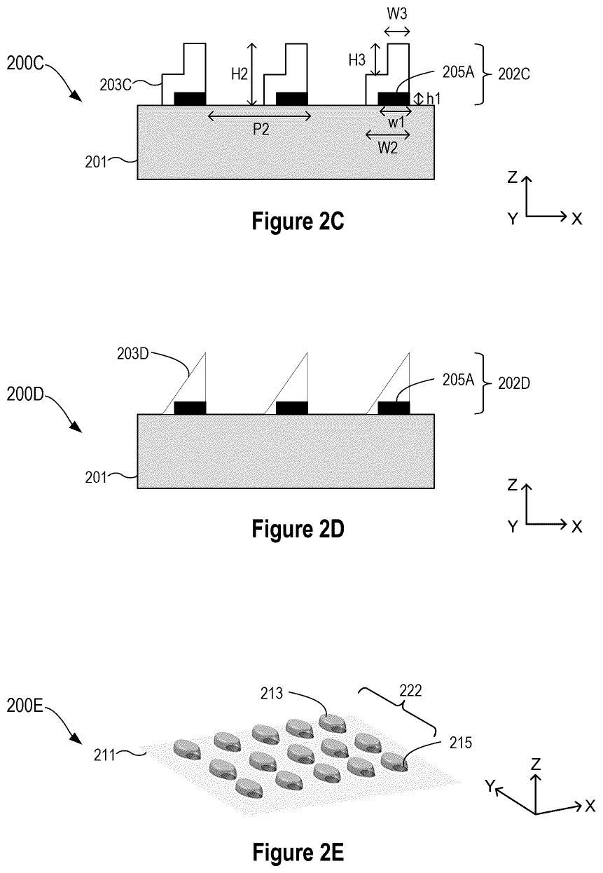

FIG. 2A shows a vertical cross-sectional view of an optical apparatus 200A, and FIG. 2B shows a top-down view along the line cut AA′ in FIG. 2A in accordance with some embodiments of the present disclosure. The optical apparatus 200A can include a waveguide combiner that includes a waveguide structure 201 and a grating pattern 202A positioned on a surface 201′ of the waveguide structure 201. The grating pattern 202A includes a plurality of protrusion structures 203A. A plurality of insert structures 205A can each be positioned in a respective one of the protrusion structures 203A.

In some embodiments, the waveguide structure 201 corresponds to the waveguide structure 113. The grating pattern 202A is positioned in at least one region selected from the group consisting of the incoupling region 112, the waveguide region 114 and the outcoupling region 116. In other words, the grating pattern 202A corresponds to at least one selected from the group consisting of the incoupler 111, the waveguide structure 113 and the outcoupler 115. Preferably, the grating pattern 202A corresponds to the incoupler 111 in the incoupling region 112. Descriptions of the present disclosure will hereinafter be focused on the grating pattern 202A configured as an incoupler merely for illustrative purposes and are not limiting.

The protrusion structures 203A can include a first material 203 that has a first refractive index (RI). The first material 203 is a high-refractive-index material. Accordingly, the first RI is larger than 1.5, preferably from 2.0 to 2.6, preferably from 2.3 to 2.5. For instance, the first RI can be 2.0, 2.1, 2.2, 2.3, 2.4, 2.5, 2.6 or any values therebetween. The first material 203 can include, but is not limited to, a glass (e.g. a silica glass, a chalcogenide glass, a borosilicate glass, etc.), a polymer (e.g. silicone, polysiloxane, silsequioxane, polyacrylate, polyimide, polymethyl methacrylate, polynorborene, an epoxy resin, etc.), a ceramic (e.g. (Ba,Ca)(Ti,Mg,Ta)O₃, Ba(Sn,Zr,Mg,Ta)O₃, yttria-containing zirconia, etc.) and/or the like. The glass often needs to be treated for example by doping the glass with one or more metal oxides (e.g. PbO, BaO, La₂O₃ and/or the like) during the glass manufacturing process to raise the RI, compared to an untreated glass, in order to achieve the first RI. As a result, the glass is also referred to as a treated glass or doped glass in the present disclosure. Similarly, the polymer may be treated or doped with one or more metal oxides to raise its RI.

The insert structures 205A can include a second material 205 that is reflective to light such as the aforementioned incident light beam. For example, the second material 205 can include, but are not limited to, a metal material such as aluminum (Al), copper (Cu), ruthenium, tungsten, titanium, niobium, molybdenum, tantalum, nickel, chromium, gold, germanium, silver, platinum and/or the like. Preferably, the insert structures 205A can include Al, Cu or both. The second material 205 can have a reflection factor (or reflection coefficient) of at least one wavelength of visible light (e.g. the aforementioned incident light beam) in a range of 50% to 100%, e.g. 50%, 55%, 60%, 70%, 80%, 90%, 95%, 98%, 100%, or any values therebetween.

The waveguide structure 201 can include a third material that has a second RI. The third material is transparent and is a high-refractive-index material. Accordingly, the second RI is larger than 1.5, preferably from 1.5 to 2.3, preferably from 1.7 to 2.0. For instance, the second RI can be 1.5, 1.6, 1.7, 1.8, 1.9, 2.0, 2.1, 2.2, 2.3 or any values therebetween. The third material can include, but is not limited to, a glass (e.g. a silica glass, a chalcogenide glass, a borosilicate glass, etc.), a polymer (e.g. silicone, polysiloxane, silsequioxane, polyacrylate, polyimide, polymethyl methacrylate, polynorborene, an epoxy resin, etc.), a ceramic (e.g. (Ba,Ca)(Ti,Mg,Ta)O₃, Ba(Sn,Zr,Mg,Ta)O₃, etc.), and the like. The glass often needs to be treated for example by doping the glass with one or more metal oxides (e.g. PbO, BaO, La₂O₃ and/or the like) during the glass manufacturing process to raise the RI, compared to an untreated glass, in order to achieve the third RI. As a result, the glass is also referred to as a treated glass in the present disclosure. Similarly, the polymer may be treated or doped with one or more metal oxides to raise its RI. Preferably, the third material includes a treated glass.

In some embodiments, the first RI of the protrusion structures 203A is larger than the second RI of the waveguide structure 201 while the insert structures 205A are reflective. Therefore, the protrusion structures 203A and the insert structures 205A can be configured to redirect the aforementioned incident light beam into the waveguide structure 201. In a non-limiting example, the insert structures 205A includes Cu, Al or both while the waveguide structure 201 includes a treated glass having an RI of 1.7 to 2.0, and the protrusion structures 203A have an RI of 2.3 to 2.5.

The grating pattern 202A can include a plurality of parallel lines that extend in the Y direction and spaced apart from one another along the X direction. A pitch dimension P1 of the grating pattern 202A can range from 200 nm to 570 nm e.g. 200 nm, 250 nm, 300 nm, 400 nm, 500 nm, 550 nm, 570 nm or any values therebetween. A width W1 of the protrusion structures 203A can range from 100 nm to 450 nm e.g. 100 nm, 150 nm, 200 nm, 300 nm, 400 nm, 450 nm or any values therebetween. A height H1 of the protrusion structures 203A can range from 100 nm to 300 nm e.g. 100 nm, 150 nm, 200 nm, 250 nm, 300 nm or any values therebetween. A width w1 of the insert structures 205A is smaller than W1. w1/W1 can range from 0.1 to 0.9 e.g. 0.1, 0.2, 0.3, 0.4, 0.5, 0.6, 0.7, 0.8, 0.9 or any values therebetween, preferably from 0.3 to 0.7. A height h1 of the insert structures 205A is smaller than H1. h1/H1 can range from 0.01 to 0.9 e.g. 0.01, 0.05, 0.1, 0.2, 0.3, 0.4, 0.5, 0.6, 0.7, 0.8, 0.9 or any values therebetween. Preferably, h1/H1 is 0.05 to 0.2. Preferably, h1 is 1 nm to 50 nm e.g. 1 nm, 2 nm, 5 nm, 10 nm, 20 nm, 30 nm, 40 nm, 45 nm, 50 nm or any values therebetween. In a non-limiting example, P1 is 550 nm while W1 is 320 nm, and H1 is 260 nm. w1 is 200 nm, and h1 is 10 nm. Note that dimensions mentioned herein are merely for illustrative purposes and are not limiting.

The grating pattern 202A includes a plurality of asymmetrical grating elements. For instance, asymmetry can be defined as not identical in shape and/or optical properties (e.g. an index of refraction, a reflection factor, etc.) on two sides of a vertical centerline of a grating element. Consider a grating element 202a for example. A protrusion structure 203a has a vertical centerline BB′. An insert structure 205a is offset relative to the vertical centerline BB′, meaning that a center of the insert structure 205a is spaced apart from the vertical centerline BB′. As a result, the grating element 202a is asymmetrical in at least the index of refraction and the reflection factor on two sides of the vertical centerline BB′.

Additionally, the insert structure 205a can be positioned on an edge of the protrusion structure 203a. That is, the insert structure 205a has a first side surface 205a′ covered by the protrusion structure 203a and a second side surface 205a″ exposed (e.g. not covered by the protrusion structure 203a).

Further, the incident light beam may enter the optical apparatus 200A at any angle from any direction depending on specific applications. For example, the incident light beam can enter the waveguide structure 201 in the Z direction and traverse the waveguide structure 201 before reaching the surface 201′ of the waveguide structure 201 and being redirected back to the waveguide structure 201 by the grating pattern 202A.

In some embodiments, FIGS. 2A and 2A′ illustrate a constant pitch grating (e.g. 202A) on the backside (e.g. 201′) of a high-refractive-index glass waveguide (e.g. 201) used for light incoupling. By depositing a metal or reflective material (e.g. 205A) asymmetrically within the grating (e.g. 202A), it is possible to enhance the light efficiency of the incoupler. FIGS. 2A and 2A′ demonstrate a structure desired in a binary grating structure, where the substrate (e.g. 201) is a high-refractive-index, transparent glass suitable as a waveguide and the backside binary grating (e.g. 202A) includes another high-refractive-index material patterned in a constant pitch manner. The metal or reflective material (e.g. 205A) can be deposited to create an asymmetric response in the light propagation and improve efficiency by enhancing total internal reflection.

FIG. 2B shows a vertical cross-sectional view of an optical apparatus 200B in accordance with another embodiment of the present disclosure. The embodiment of the optical apparatus 200B is similar to the embodiment of the optical apparatus 200A. Note that similar or identical components are labeled with similar or identical numerals in the present disclosure unless specified otherwise. Descriptions that have been provided once will thus be omitted for simplicity purposes.

As shown in FIG. 2B, the optical apparatus 200B includes a grating pattern 202B that corresponds to the grating pattern 202A. However, the grating pattern 202B includes protrusion structures 203B and insert structures 205B which are positioned differently. Consider a protrusion structure 203b and an insert structure 205b for example. The insert structure 205b is not positioned on an edge of the protrusion structure 203b. Rather, the insert structure 205b has a first side surface 205b′ covered by the protrusion structure 203b and a second side surface 205b″ also covered by the protrusion structure 203b. The insert structure 205b is offset relative to a vertical centerline CC′ of a grating element 202b, meaning that a center of the insert structure 205b is spaced apart from the vertical centerline CC′. As a result, the grating element 202b is asymmetrical in at least the index of refraction and the reflection factor on two sides of the vertical centerline CC′.

FIG. 2C shows a vertical cross-sectional view of an optical apparatus 200C in accordance with yet another embodiment of the present disclosure. The embodiment of the optical apparatus 200C is similar to the embodiment of the optical apparatus 200A. In FIG. 2C, the optical apparatus 200C includes a grating pattern 202C that corresponds to the grating pattern 202A. However, the grating pattern 202C includes protrusion structures 203C that have a different cross-sectional shape in the XY plane from the protrusion structures 203A. Specifically, the protrusion structures 203C have a staircase shape in a cross-sectional view in the XY plane. While only two stair steps are shown here for illustrative purposes, it should be understood that the protrusion structures 203C can have any number of stair steps.

In some embodiments, a pitch dimension P2 of the grating pattern 202C can range from 250 nm to 650 nm e.g. 250 nm, 300 nm, 350 nm, 400 nm, 500 nm, 550 nm, 600 nm, 650 nm or any values therebetween. A width W2 of the protrusion structures 205C can range from 200 nm to 450 nm e.g. 200 nm, 250 nm, 300 nm, 400 nm, 450 nm or any values therebetween. A height H2 of the protrusion structures 203C can range from 100 nm to 500 nm e.g. 100 nm, 150 nm, 200 nm, 250 nm, 300 nm, 350 nm, 400 nm, 450 nm, 500 nm or any values therebetween. A width W3 of each stair step can range from 100 nm to 160 nm e.g. 100 nm, 110 nm, 120 nm, 130 nm, 140 nm, 150 nm, 160 nm or any values therebetween. A height H3 of each stair step can range from 50 nm to 200 nm e.g. 50 nm, 75 nm, 100 nm, 125 nm, 150 nm, 175 nm, 200 nm or any values therebetween. When there are N (N=2, 3, 4, 5, 6, 7, etc.) stair steps in the protrusion structures 203C, an overall height can for example be N*H3. Due to the staircase shape, h1 herein may be the same as or different from h1 in FIGS. 2A and 2A′, depending on H3, W3 and w1. For example, when w1 is larger than W3, h1 is equal to or smaller than H3. In a non-limiting example, P2 is 550 nm while W2 is 280 nm, and H2 is 280 nm. W3 is 140 nm while H3 is 140 nm. w1 is 200 nm, and h1 is 10 nm. Note that dimensions mentioned herein are merely for illustrative purposes and are not limiting.

FIG. 2D shows a vertical cross-sectional view of an optical apparatus 200D in accordance with yet another embodiment of the present disclosure. The embodiment of the optical apparatus 200D is similar to the embodiment of the optical apparatus 200A. In FIG. 2D, the optical apparatus 200D includes a grating pattern 202D that corresponds to the grating pattern 202A. However, the grating pattern 202D includes protrusion structures 203D that have a different cross-sectional shape in the XY plane from the protrusion structures 203A. Specifically, the protrusion structures 203D have a triangular shape or a slanted slope in a cross-sectional view in the XY plane.

FIG. 2E shows a perspective view of an optical apparatus 200E in accordance with yet another embodiment of the present disclosure. Herein, the optical apparatus 200E includes a grating pattern 222 which includes protrusion structures 213 and insert structures 215. The protrusion structures 213 can have an elliptical shape in the XY plane. The insert structures 215 may also have an elliptical shape in the XY plane or alternatively a different shape.

Note that the embodiments of a grating pattern (e.g. 202A, 202B, 202C, 202D and 222) shown in FIGS. 2A, 2A′, 2B, 2C, 2D and 2E are for illustrative purposes only and are not limiting. Shapes of protrusion structures (e.g. 203A, 203B, 203C, 203D and 213) and shapes of insertion structures (e.g. 205A, 205B and 215) are not particularly limited, and other shapes (e.g. cylinders, elliptical shapes, trapezoid shapes, irregular shapes etc.) are also possible. A metal insertion can optionally map a respective protrusion structure or can be a different shape entirely. That is, a given insertion structure may have a same shape as a respective protrusion structure while being proportionally smaller. Alternatively or additionally, a particular insertion structure may have a different shape from a respective protrusion structure.

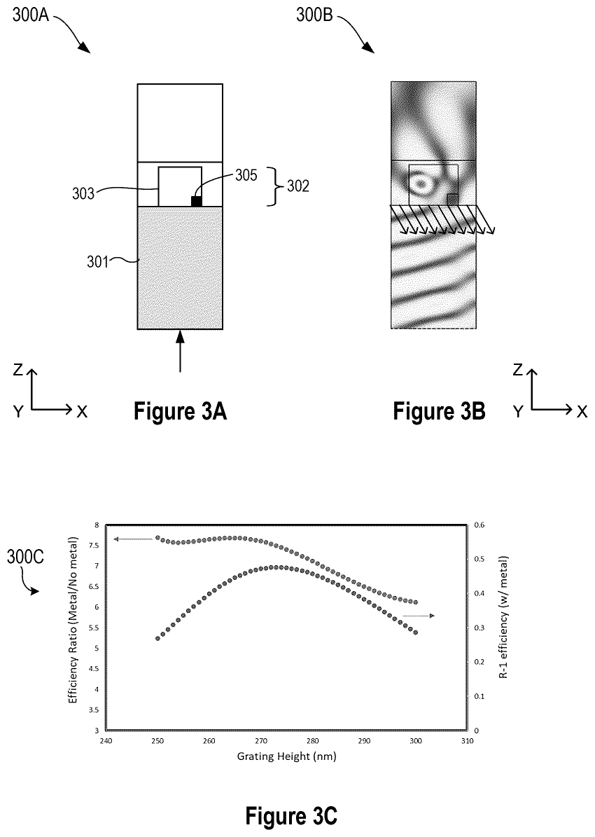

FIGS. 3A, 3B and 3C respectively show a vertical cross-sectional view of an optical apparatus 300A, a vertical cross-sectional view of an electrical field 300B of the optical apparatus 300A and efficiency data 300C of the optical apparatus 300A in accordance with some embodiments of the present disclosure.

As shown, the optical apparatus 300A includes a waveguide structure 301 and a grating pattern 302 positioned thereon. The grating pattern 302 includes a protrusion structure 303 and an insert structure 305. For simplicity purposes, only one grating element including the protrusion structure 303 and the insert structure 305 is shown. It should be understood that the grating pattern 302 includes a plurality of protrusion structures and a plurality of insert structures.

In the examples of FIGS. 3A and 3B, the protrusion structure 303 has a width of about 320 nm in the X direction and a height of about 260 nm in the Z direction. The insert structure 305 has a width of about 60 nm in the X direction and a height of about 70 nm in the Z direction. The grating pattern 302 includes parallel lines and has a pitch of about 550 nm in the X direction. An incident light beam has a wavelength of 500 nm. Here, the waveguide structure 301 is a treated glass that is transparent and has an RI of 1.7 to 2.0. The protrusion structure 303 has an RI of 2.3 to 2.5. The insert structure 305 is Al or Cu.

In the example of FIG. 3C, dimensions are the same as discussed in FIGS. 3A and 3B, except that “Grating Height”, which refers to the height of the protrusion structure 303 in the Z direction, is varied while other dimensions are kept constant. FIG. 3C demonstrates the ratio of efficiency improvement obtained when using a metal insert as a function of the grating height. The asymmetric nature of the structure focuses the light to exhibit total reflection, resulting in efficiency improvements up to 7.5 times for example. Further combinations of metal or high-refractive-index gratings may result in even stronger efficiency improvements.

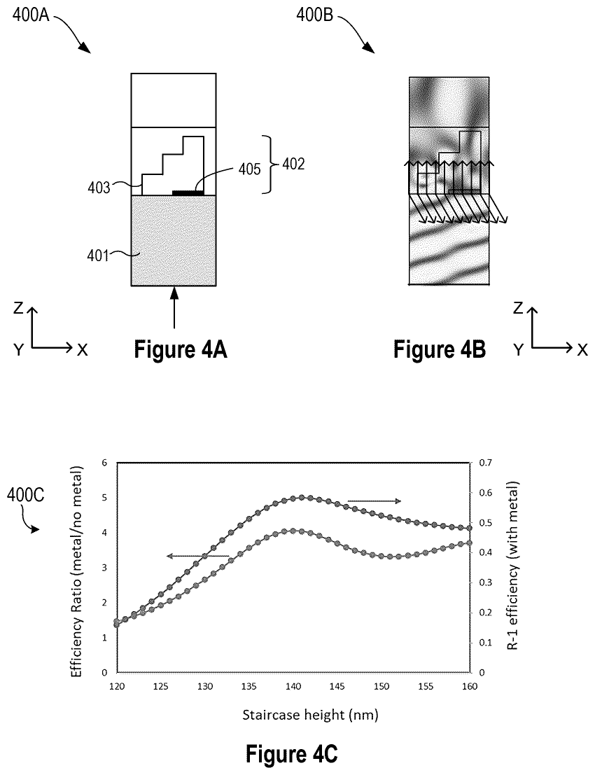

FIGS. 4A, 4B and 4C respectively show a vertical cross-sectional view of an optical apparatus 400A, a vertical cross-sectional view of an electrical field 400B of the optical apparatus 400A and efficiency data 400C of the optical apparatus 400A in accordance with some embodiments of the present disclosure.

As shown, the optical apparatus 400A includes a waveguide structure 401 and a grating pattern 402 positioned thereon. The grating pattern 402 includes a protrusion structure 403 and an insert structure 405. For simplicity purposes, only one grating element including the protrusion structure 403 and the insert structure 405 is shown. It should be understood that the grating pattern 402 includes a plurality of protrusion structures and a plurality of insert structures.

In the examples of FIGS. 4A and 4B, the protrusion structure 403 has a width of about 420 nm in the X direction and a height of about 420 nm in the Z direction. The protrusion structure 403 includes three stair steps, each of which has a width of about 140 nm in the X direction and a height of about 140 nm in the Z direction. The insert structure 405 has a width of about 210 nm in the X direction and a height of about 20 nm in the Z direction. The grating pattern 402 has a pitch of about 550 nm in the X direction. An incident light beam has a wavelength of 500 nm. Here, the waveguide structure 401 is a treated glass that is transparent and have an RI of 1.7 to 2.0. The protrusion structure 403 has an RI of 2.3 to 2.5. The insert structure 405 is Al or Cu.

In the example of FIG. 4C, dimensions are the same as discussed in FIGS. 4A and 4B, except that “Staircase Height”, which refers to the height of each stair step of the protrusion structure 403 in the Z direction, is varied. FIG. 4C demonstrates the ratio of efficiency improvement obtained when using a metal insert as a function of the staircase height. The asymmetric nature of the structure focuses the light to exhibit total reflection, resulting in efficiency improvements up to 4 times for example. Further combinations of metal or high-refractive-index gratings may result in even stronger efficiency improvements.

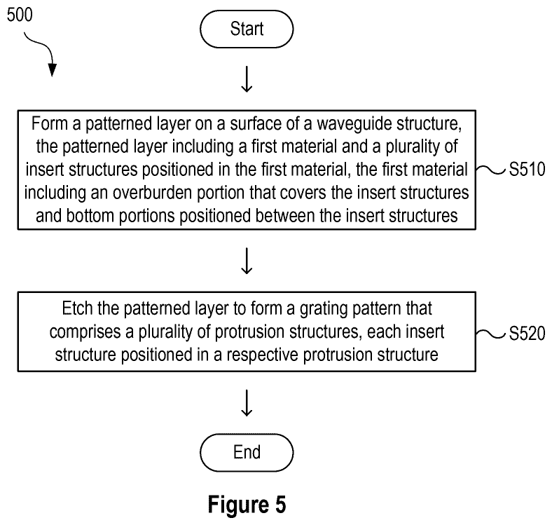

FIG. 5 shows a flow chart of a process 500 for manufacturing an optical apparatus (e.g. 200A, 200B, 200C, 200D, 200E or the like), in accordance with some embodiments of the present disclosure. At step S510, a patterned layer is formed on a surface of a waveguide structure. The patterned layer includes a first material and a plurality of insert structures positioned in the first material. The first material includes an overburden portion that covers the insert structures and bottom portions positioned between the insert structures. At step S520, the patterned layer is etched to form a grating pattern that includes a plurality of protrusion structures. Each insert structure is positioned in a respective protrusion structure.

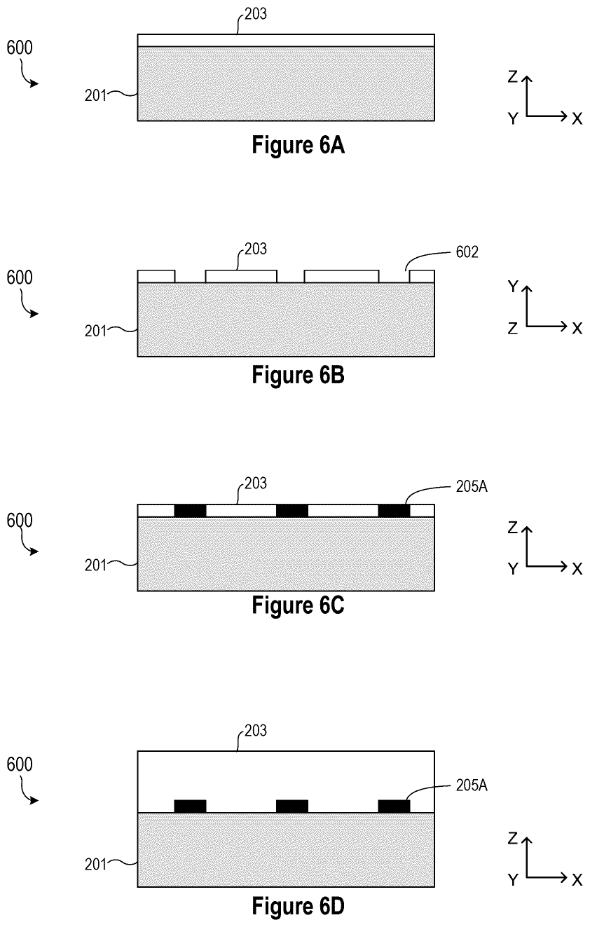

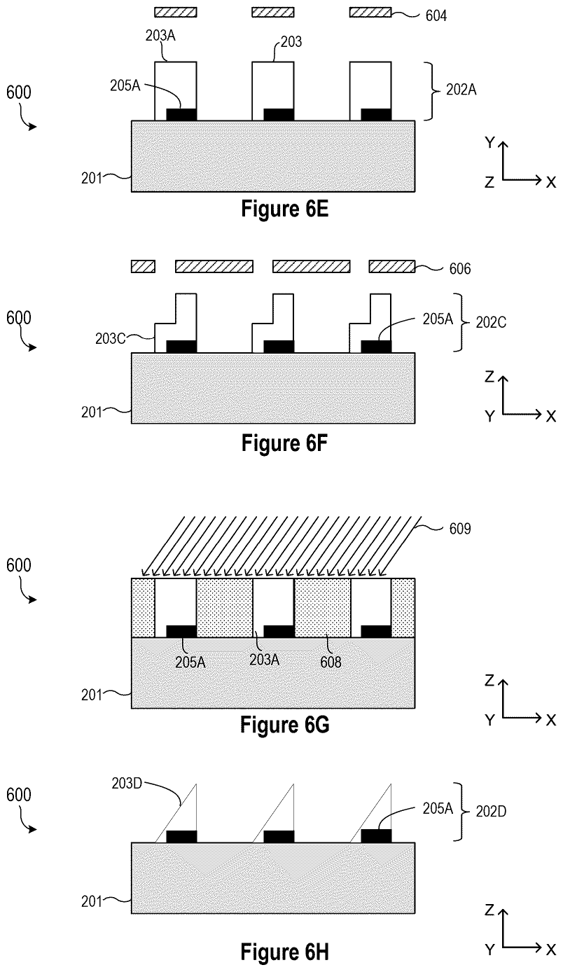

FIGS. 6A, 6B, 6C, 6D, 6E, 6F, 6G and 6H show vertical cross-sectional views of an optical apparatus 600 at various intermediate steps of manufacturing, in accordance with some embodiments of the present disclosure.

In FIG. 6A, a film of the first material 203 is formed on the waveguide structure 201. In FIG. 6B, the film of the first material 203 is etched to form openings 602, for example by photolithography using a photoresist and a photomask (not shown). In FIG. 6C, the insert structures 205A are formed in the openings 602, for example by metal deposition of Al or Cu, optionally followed by a chemical-mechanical polishing (CMP) process or a metal etching process to remove excessive metal material. In FIG. 6D, the first material 203 is deposited again. As a result, the first material 203 has bottom portions positioned between the insert structures 205A and an overburden portion positioned over the bottom portions and over the insert structures 205A. In FIG. 6E, the first material 203 is etched to form the protrusion structures 203A and thus the grating pattern 202A, for example by photolithography using a photoresist (not shown) and a photomask 604. As a result, the optical apparatus 600 herein can become or correspond to the optical apparatus 200A in FIGS. 2A and 2A′.

In some embodiments, FIGS. 6A, 6B, 6C, 6D and 6E outline one process flow for creating a binary grating surface relief grating (e.g. 202A). The process flow can begin with depositing a high refractive index film (e.g. 203) on a waveguide substrate (e.g. 201), followed by photoresist spin-coat, post-exposure bake, and lithography development at the critical dimension of the desired metal film (e.g. 205A). An etching step takes place through the high refractive index film (e.g. 203) to form trenches (e.g. 602) the size of the desired metal insert (e.g. 205A), followed by the photoresist strip. Metal deposition in the trenches (e.g. 602) can occur through chemical vapor deposition techniques. After optional planarization or polishing, an additional high refractive index film (e.g. 203) is deposited at a desired design height. Another lithography and etch processing process can enable the construction of the binary grating (e.g. 202A) with the appropriate metal insert (e.g. 205A).

FIG. 6F can expand on the process flow in FIGS. 6A, 6B, 6C, 6D and 6E and add lithography and etching processes that can create a staircase grating structure (e.g. 202C). For example, the optical apparatus 600 in FIG. 6F can be obtained by further etching the first material 203 in FIG. 6E to form the protrusion structures 203C and thus the grating pattern 202C, for example by an additional photolithography process using a photomask 606. As a result, the optical apparatus 600 herein can become or correspond to the optical apparatus 200C in FIG. 2C.

FIGS. 6G and 6H can expand on the process flow in FIGS. 6A, 6B, 6C, 6D and 6E. For example, the optical apparatus 600 in FIG. 6G can be obtained by forming protection structures 608 between the protrusion structures 203A in FIG. 6E. Then, an angled etching species 609 can be utilized to selectively etch the protrusion structures 203A relative to the protection structures 608, at an angle to form the protrusion structures 203D and thus the grating pattern 202D in FIG. 6H. The angled etching species 609 can include ions, radicals and/or the like. An angle of the angled etching species 609 and the Z axis depends on dimensions of the protrusion structures 203D and may range from 10° to 80°, preferably from 30° to 60°, preferably from 40° to 50°, preferably about 45°. Such an angled etching process can be accomplished by reactive ion etching, ion beam etching, sputter etching, plasma etching, atomic layer etching, etc., preferably by reactive ion etching and/or plasma etching. Next, the protection structures 608 are removed. As a result, the optical apparatus 600 herein can become or correspond to the optical apparatus 200D in FIG. 2D.

Referring back to FIG. 6E, features of the photomask 604 are aligned with the insert structures 205A so that the insert structures 205A are each positioned on an edge of a respective protrusion structure (e.g. 203A). While not shown, it should be understood that the photomask 604 can be positioned differently or a different mask can be used. For instance, features of the photomask 604 may not be aligned with the insert structures 205A. Accordingly, the protrusion structures 203B and the grating pattern 202B can be formed, and the optical apparatus 600 can become or correspond to the optical apparatus 200B in FIG. 2B.

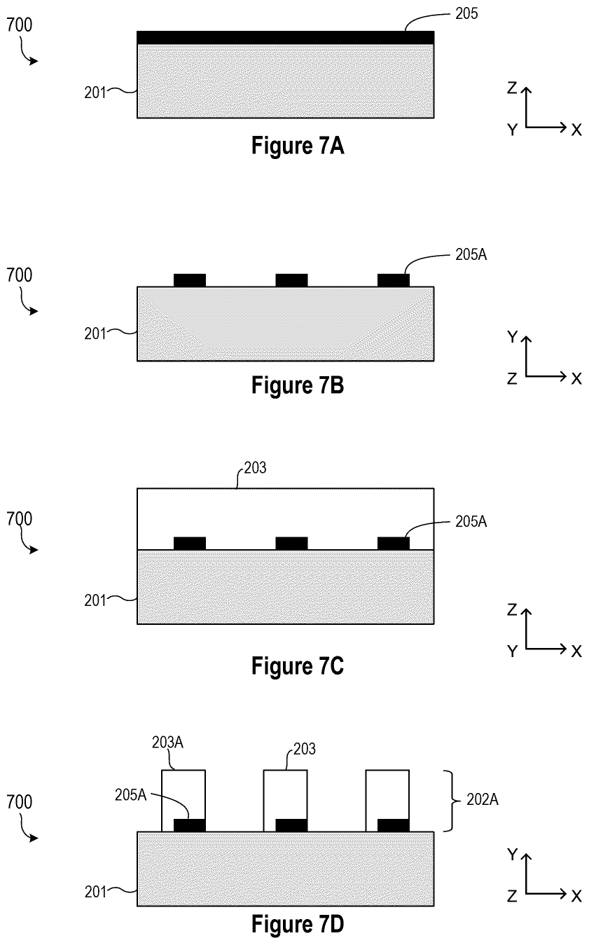

FIGS. 7A, 7B and 7C show vertical cross-sectional views of an optical apparatus 700 at various intermediate steps of manufacturing, in accordance with some embodiments of the present disclosure.

In FIG. 7A, a film of the second material 205 is formed on the waveguide structure 201. In FIG. 7B, the film of the second material 205 is etched to form the insert structures 205A, for example by photolithography using a photoresist and a photomask (not shown). In FIG. 7C, the first material 203 is deposited, optionally followed by a CMP process or an etching process for planarization. Note that the optical apparatus 700 herein can become or correspond to the optical apparatus 600 in FIG. 6D. Accordingly, the optical apparatus 700 may further be subjected to one or more processes shown in FIGS. 6E, 6F, 6G and/or 6H.

In some embodiments, FIGS. 7A, 7B and 7C outline at least part of an additional process flow for creating a binary grating surface relief grating. The process flow can begin with depositing a metal film (e.g. 205) on a waveguide substrate (e.g. 201), followed by photoresist spin-coat, post-exposure bake, and lithography development at the critical dimension of the desired metal (e.g. 205). An etching step takes place through the metal film (e.g. 205) to form the desired metal insert size. Deposition of a high refractive index film (e.g. 203) takes place. After optional planarization, an additional lithography and etch process takes place to form the binary grating of desired critical dimension as shown in FIG. 7D.

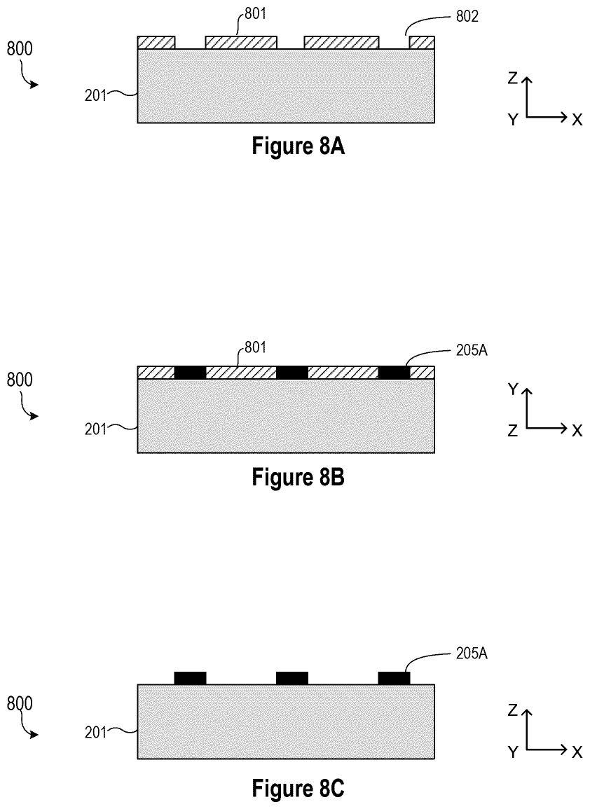

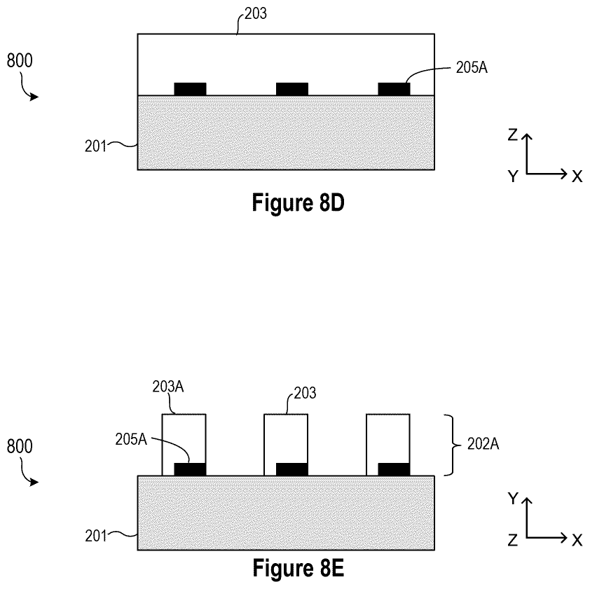

FIGS. 8A, 8B, 8C and 8D show vertical cross-sectional views of an optical apparatus 800 at various intermediate steps of manufacturing, in accordance with some embodiments of the present disclosure.

In FIG. 8A, a photoresist layer 801 can be patterned by photolithography to form openings 802. In FIG. 8B, the insert structures 205A are formed in the openings 802, for example by metal deposition optionally followed by a CMP process or a metal etching process to remove excessive metal material. In FIG. 8C, the photoresist layer 801 is removed. In FIG. 8D, the first material 203 is deposited, optionally followed by a CMP process or an etching process for planarization. Note that the optical apparatus 800 herein can become or correspond to the optical apparatus 600 in FIG. 6D. Accordingly, the optical apparatus 800 may further be subjected to one or more processes shown in FIGS. 6E, 6F, 6G and/or 6H.

In some embodiments, FIGS. 8A, 8B, 8C and 8D outline at least part of an additional process flow for creating a binary grating surface relief grating. The process flow begins with a photoresist lithography process to create trench structures (e.g. 802) the size of metal inserts (e.g. 205A). After metal deposition and any optional planarization (CMP or etch back) the photoresist (e.g. 801) is stripped. Next a high refractive index film (e.g. 203) is deposited, and another photoresist and lithography process takes place followed by etching to form the desired binary grating as shown in FIG. 8E.

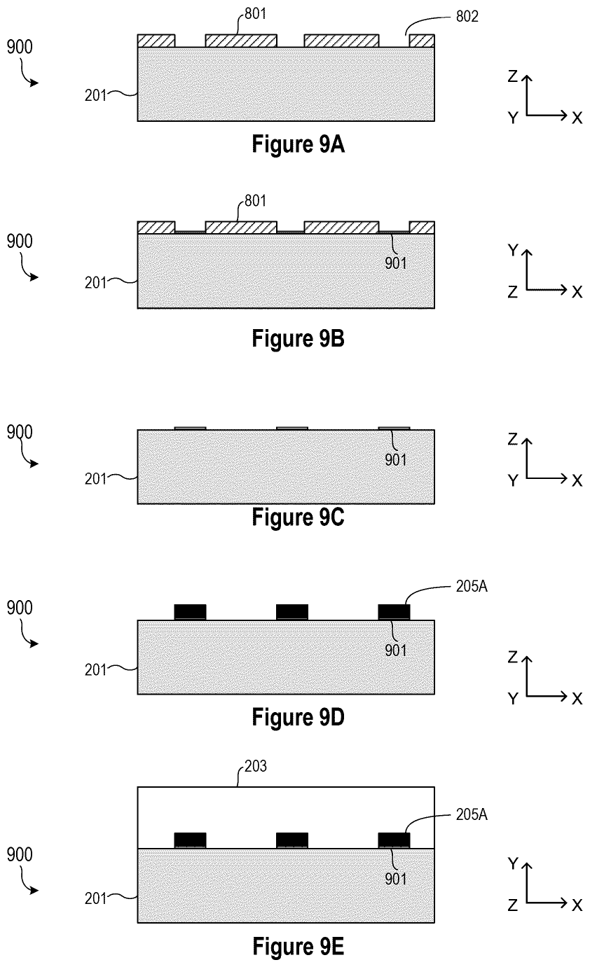

FIGS. 9A, 9B, 9C, 9D and 9E show vertical cross-sectional views of an optical apparatus 900 at various intermediate steps of manufacturing, in accordance with some embodiments of the present disclosure.

In FIG. 9A, the photoresist layer 801 can be patterned by photolithography to form the openings 802. In FIG. 9B, a self-assembled monolayer (SAM) 901 can be formed in the opening 802. Note that the SAM 901 may be a monolayer or may include any number of layers. In FIG. 9C, the photoresist layer 801 is removed. In FIG. 9D, the insert structures 205A are grown from the SAM 901, for example by selective deposition. In FIG. 9E, the first material 203 is deposited, optionally followed by a CMP process or an etching process for planarization. Note that the optical apparatus 900 herein is similar to the optical apparatus 600 in FIG. 6D. Accordingly, the optical apparatus 900 may further be subjected to one or more processes shown in FIGS. 6E, 6F, 6G and/or 6H.

While not shown, the SAM 901 can be alternatively used to block metal deposition. In other words, the insert structures 205A can be formed where the waveguide structure 201 is not covered by the SAM 901. The first material 203 is then deposited after the SAM 901 is removed.

In some embodiments, FIGS. 9A, 9B, 9C, 9D and 9E outline at least part of an additional process flow for creating a binary grating surface relief grating. The process flow can begin with a photolithography process followed by self-assembled monolayer (SAM) deposition. After photoresist strip, the self-assembled monolayer (e.g. 901) can act to initiate or promote bottom-up metal growth. After SAM removal, a high refractive index film (e.g. 203) is deposited, and a photoresist and lithography process can be used to form a binary grating.

In the preceding description, specific details have been set forth, such as a particular geometry of a processing system and descriptions of various components and processes used therein. It should be understood, however, that techniques herein may be practiced in other embodiments that depart from these specific details, and that such details are for purposes of explanation and not limitation. Embodiments disclosed herein have been described with reference to the accompanying drawings. Similarly, for purposes of explanation, specific numbers, materials, and configurations have been set forth in order to provide a thorough understanding. Nevertheless, embodiments may be practiced without such specific details. Components having substantially the same functional constructions are denoted by like reference characters, and thus any redundant descriptions may be omitted.

Various techniques have been described as multiple discrete operations to assist in understanding the various embodiments. The order of description should not be construed as to imply that these operations are necessarily order dependent. Indeed, these operations need not be performed in the order of presentation. Operations described may be performed in a different order than the described embodiment. Various additional operations may be performed and/or described operations may be omitted in additional embodiments.

“Substrate” or “wafer” as used herein generically refers to an object being processed in accordance with the invention. The substrate may include any material portion or structure of a device, particularly a semiconductor or other electronics device, and may, for example, be a base substrate structure, such as a semiconductor wafer, reticle, or a layer on or overlying a base substrate structure such as a thin film. Thus, substrate is not limited to any particular base structure, underlying layer or overlying layer, patterned or un-patterned, but rather, is contemplated to include any such layer or base structure, and any combination of layers and/or base structures. The description may reference particular types of substrates, but this is for illustrative purposes only.

The substrate can be any suitable substrate, such as a silicon (Si) substrate, a germanium (Ge) substrate, a silicon-germanium (SiGe) substrate, and/or a silicon-on-insulator (SOI) substrate. The substrate may include a semiconductor material, for example, a Group IV semiconductor, a Group III-V compound semiconductor, or a Group II-VI oxide semiconductor. The Group IV semiconductor may include Si, Ge, or SiGe. The substrate may be a bulk wafer or an epitaxial layer.

Those skilled in the art will also understand that there can be many variations made to the operations of the techniques explained above while still achieving the same objectives of the invention. Such variations are intended to be covered by the scope of this disclosure. As such, the foregoing descriptions of embodiments of the invention are not intended to be limiting. Rather, any limitations to embodiments of the invention are presented in the following claims.

What is claimed is:

1. An optical apparatus, comprising:
a waveguide structure;
a grating pattern positioned on a surface of the waveguide structure and comprising a plurality of protrusion structures; and
a respective insert structure positioned in each of the protrusion structures and on the surface of the waveguide structure, resulting in a plurality of insert structures, wherein
the protrusion structures have a higher refractive index (RI) than the waveguide structure,
the insert structures are reflective to an incident light beam, and
the protrusion structures and the insert structures are configured to redirect the incident light beam into the waveguide structure.

2. The optical apparatus of claim 1, wherein:
the surface of the waveguide structure is in direct contact with the insert structures.

3. The optical apparatus of claim 1, wherein:
the surface of the waveguide structure is in direct contact with the protrusion structures.

4. The optical apparatus of claim 1, wherein:
the insert structures each are offset from a center of a respective protrusion structure.

5. The optical apparatus of claim 1, wherein:
the insert structures each has a respective first side surface covered by a respective protrusion structure and a respective second side surface covered by the respective protrusion structure or exposed.

6. The optical apparatus of claim 1, wherein:
the protrusion structures have a rectangular, staircase or triangular shape in a cross-sectional view.

7. The optical apparatus of claim 1, wherein:
the insert structures have a reflection factor of the incident light beam of 50% to 100%.

8. The optical apparatus of claim 1, wherein:
the protrusion structures have a first RI of 2.0 to 2.6, and
the waveguide structure has a second RI of 1.7 to 2.3.

9. The optical apparatus of claim 1, wherein:
the insert structures comprise a metal material.

10. The optical apparatus of claim 1, wherein:
the waveguide structure is transparent and comprises a treated glass, and
the insert structures comprise Al or Cu.

11. The optical apparatus of claim 1, wherein:
the waveguide structure comprises an incoupling region, a waveguide region and an outcoupling region, and
the waveguide structure, the protrusion structures and the insert structures form a waveguide combiner.

12. The optical apparatus of claim 11, wherein:
the protrusion structures and the insert structures are positioned in the incoupling region.

13. The optical apparatus of claim 11, further comprising:
a light source configured to provide the incident light beam.

14. A method of manufacturing an optical apparatus, the method comprising:
forming a patterned layer on a surface of a waveguide structure, the patterned layer comprising a first material and a plurality of insert structures positioned in the first material, the first material including an overburden portion that covers the insert structures and bottom portions positioned between the insert structures; and
etching the patterned layer to form a grating pattern that comprises a plurality of protrusion structures, each insert structure positioned in a respective protrusion structure, wherein
the protrusion structures have a higher refractive index (RI) than the waveguide structure,
the insert structures comprise a second material that is reflective to an incident light beam,
the protrusion structures and the insert structures are configured to redirect the incident light beam into the waveguide structure, and
the surface of the waveguide structure is in direct contact with the insert structures.

15. The method of claim 14, wherein the protrusion structures each have a rectangular shape in a cross-sectional view, the method further comprising:
etching the protrusion structures so that the protrusion structures have a staircase shape in the cross-sectional view.

16. The method of claim 14, wherein the protrusion structures each have a rectangular shape in a cross-sectional view, the method further comprising:
etching the protrusion structures at an angle so that the protrusion structures have a triangular shape in the cross-sectional view.

17. The method of claim 14, further comprising:
forming a film of the first material on the waveguide structure;
etching the film of the first material to form the bottom portions;
forming the insert structures between the bottom portions; and
forming the overburden portion over the insert structures and the bottom portions.

18. The method of claim 14, further comprising:
forming a film of the second material on the waveguide structure;
etching the film of the second material to form the insert structures; and
depositing the first material to form the bottom portions and the overburden portion.

19. The method of claim 14, further comprising:
forming a patterned photoresist on the waveguide structure;
depositing the second material into openings of the patterned photoresist to form the insert structures;
removing the patterned photoresist; and
depositing the first material to form the bottom portions and the overburden portion.

20. The method of claim 19, wherein the depositing the second material comprises:
forming a self-assembled layer in the openings of the patterned photoresist; and
depositing the second material selectively on the self-assembled layer.
